(19) United States
(12) Patent Application Publication
(10) Pub. No.: US 2021/0241612 A1
(43) Pub. Date: Aug. 5, 2021

(54) SYSTEMS AND METHODS FOR ZONE TAGGING

(71) Applicant: Toyota Motor Engineering & Manufacturing North America, Inc., Plano, TX (US)

(72) Inventors: Seyhan Ucar, Mountain View, CA (US); Takamasa Higuchi, Mountain View, CA (US); Onur Altintas, Mountain View, CA (US)

(21) Appl. No.: 16/782,655

(22) Filed: Feb. 5, 2020

(51) Int. Cl. G08G 1/01; G08G 1/04; G01C 21/34; G06N 5/02

(52) U.S. Cl. CPC G08G 1/0129; G08G 1/0141; G06N 5/022; G01C 21/3461; G08G 1/04

(57) ABSTRACT

System, methods, and other embodiments described herein relate to improving awareness about aspects of traveling through a transportation network. In one embodiment, a method includes analyzing observations about a location to correlate the observations into knowledge about the location. The method includes defining a tag for a zone associated with the location according to a pattern within a knowledge set that includes the knowledge for the zone. The pattern corresponding with a zone attribute of the zone. The method includes distributing a mapping of tags including at least the tag to one or more entities that are to travel through the zone.

### TECHNICAL FIELD

The subject matter described herein relates, in general, to identifying common characteristics of different segments of roadways from gathered knowledge, and, more particularly, to tagging traffic zones with the common knowledge to improve awareness about aspects of traffic.

### BACKGROUND

Various entities, such as vehicles, may be equipped with sensors that facilitate perceiving vehicles, obstacles, pedestrians, and additional aspects of a surrounding environment. For example, a vehicle may be equipped with a light detection and ranging (LIDAR) sensor that uses light to scan the surrounding environment while further processing elements associated with the LIDAR analyze acquired data to detect the presence of objects and other features of the surrounding environment. In further examples, additional/alternative sensors such as cameras may be implemented to acquire additional sensor data about the surrounding environment from which a system derives a contextual awareness about aspects of the surrounding environment. The sensor data can be useful in various circumstances for improving perceptions of the surrounding environment so that systems such as autonomous driving systems can perceive the noted aspects and accurately plan and navigate accordingly.

In general, the further awareness is developed by the vehicle about a surrounding environment, the better a driver can be supplemented with information to assist in driving and/or the better an autonomous system can control the vehicle to avoid difficulties. However, because the sensors of the vehicle acquire the sensor data through a limited perspective (e.g., at road-level over a single observation of the environment) and for a constrained time period, the ability to develop a comprehensive assessment of aspects relating to an intersection or another traffic zone may be difficult.

The difficulties can relate to hidden or difficult to perceive aspects of the traffic zone, dynamic aspects, or other aspects that may require prior knowledge to avoid. The limited perspective from which a vehicle or other entity acquires single observations of an environment {01180757} 1 can generally constrain the available information about the traffic zone. Additionally, a limited time to acquire the sensor data, as well as limited computational time to process the data, can further constrain awareness that the vehicle may derive from such an observation. In any case, an entity navigating through the traffic zone may encounter difficulties when perceiving aspects of the surrounding environment because of the noted issues, and, as a result, may not develop a comprehensive contextual awareness of the environment.

### SUMMARY

In one embodiment, example systems and methods relate to a manner of improving awareness about aspects of a zone within a transportation network. As previously noted, observations of a single entity may be inadequate for developing sufficient awareness about various traffic patterns, events, characteristics, and other aspects of a particular zone. For example, because a single observation of a location, such as a roadway segment, from a vehicle or other entity can be temporally and spatially limited, the entity may not develop a comprehensive awareness from such an observation.

Therefore, in one embodiment, a system aggregates observations from various entities about a particular location, such as a roadway segment. An entity forms an individual observation from a single temporal instance of encountering the location. Thus, the observation can include data from multiple different sensors that may span a period of time the entity is traveling through a location like the roadway segment. As such, the aggregated observations may be from multiple different entities that encounter the roadway segment at different times and under different conditions. The observations function as evidence of different events and characteristics associated with the roadway segment, and/or a broader zone about the roadway segment. Thus, the system analyzes the observations to generate knowledge about the roadway segment. The knowledge describes a fact or belief about the presence of certain attributes of the location such as particular characteristics or occurrences of events. The aspects may include roadway geometries, dynamic traffic conditions, events (e.g., conferences) influencing travel through a location, and so on. In any case, the system processes the observations to derive the knowledge, thereby acquiring further awareness about the location.

To further leverage the knowledge, the system analyzes a collection of knowledge about the location to further determine commonalities that may influence traffic or other attributes associated with movement through the location. Thus, the system can further process the acquired knowledge to determine which characteristics and events sufficiently influence movement (e.g., traffic, dangerous areas, etc.) through a zone, including the location (e.g., roadway segment). As a result, the system identifies common zone attributes for the zone and generates tags within a map indicating the particular zone attributes. It should be noted that the zone attributes include aspects, in various embodiments, extending beyond traffic on a roadway segment and may further encompass aspects relating to pedestrians and other entities, such as a density of pedestrians, safety for walking through a zone, and so on. The tag generally outlines a location and other information such as suggested actions to improve operation (e.g., behavior, navigation, etc.) through the zone. As such, the system can distribute the mapping to other entities (e.g., vehicles, pedestrians) to increase awareness about the zone attributes. In this way, the disclosed approach improves awareness about the zone attributes for various zones thereby facilitating movement through locations by different entities.

In one embodiment, a tagging system for improving awareness about aspects of traveling through a transportation network is disclosed. The tagging system includes one or more processors and a memory communicably coupled to the one or more processors. The memory stores a zone module including instructions that when executed by the one or more processors cause the one or more processors to analyze observations about a location to correlate the observations into knowledge about the location. The zone module further includes instructions to define a tag for a zone associated with the location according to a pattern within a knowledge set that includes the knowledge for the zone. The pattern corresponds with a zone attribute zone attribute of the zone. The memory stores a mapping module including instructions that when executed by the one or more processors cause the one or more processors to distribute a mapping of tags including at least the tag to one or more entities that are to navigate through the zone.

In one embodiment, a non-transitory computer-readable medium for improving awareness about aspects of traffic associated with a transportation network and including instructions that, when executed by one or more processors, cause the one or more processors to perform one or more functions is disclosed. The instructions include instructions to analyze observations about a location to correlate the observations into knowledge about the location. The instructions include instructions to define a tag for a zone associated with the location according to a pattern within a knowledge set that includes the knowledge for the zone. The pattern corresponds with a zone attribute of the zone. The instructions include instructions to distribute a mapping of tags including at least the tag to one or more entities that are to navigate through the zone.

In one embodiment, a method for improving awareness about aspects of traffic associated with a transportation network is disclosed. In one embodiment, the method includes analyzing observations about a location to correlate the observations into knowledge about the location. The method includes defining a tag for a zone associated with the location according to a pattern within a knowledge set that includes the knowledge for the zone. The pattern corresponds with a zone attribute of the zone. The method includes distributing a mapping of tags including at least the tag to one or more entities that are to navigate through the zone.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a tagging system 170 associated with improving awareness about aspects of an area by tagging zones in a map with defining characteristics.

FIG. 3 illustrates a diagram of a tagging system 170 in a cloud-based configuration.

FIG. 4 is a flowchart illustrating one embodiment of a method associated with collecting observations.

FIG. 5 is a flowchart illustrating one embodiment of a method associated with tagging zones to improve awareness of entities moving through a transportation network.

FIG. 6 is a flowchart illustrating one embodiment of a method associated with an entity using a map that includes zone tags to facilitate movement through a region.

FIG. 7 is an illustration of an example map as may be produced by the disclosed systems and methods.

FIG. 8 is an illustration of an example scene that may be observed and tagged.

### DETAILED DESCRIPTION

Systems, methods, and other embodiments associated with a manner of improving awareness about aspects of a zone within a transportation network are disclosed herein. As previously noted, observations of a single entity may be inadequate for developing sufficient awareness about various traffic patterns, events, characteristics, and other aspects of a particular zone. By way of example, a particular road segment may include confusing traffic signs or a road geometry that causes entities (e.g., vehicles) to encounter difficulties such as wrong turns or other navigational errors. As a further example, various segments of a transportation network may experience increased risks during particular times due to the presence of pedestrians (e.g., children from a nearby school), a propensity for collisions due to weather (e.g., ice, fog, etc.), events (e.g., concerts, conferences, etc.), or other factors.

As such, because single observations acquired during an approach to the roadway segment cannot provide awareness of such complex traits about a zone, the vehicle is likely to encounter the noted risks, confusion, and traffic without prior knowledge. Accordingly, the vehicle is at an increased likelihood of encountering the noted aspects since real-time observations from acquired sensor data are not likely to inform the driver or automated vehicle systems about such occurrences due to the abstract and unapparent nature of the occurrences.

Therefore, in one embodiment, a tagging system aggregates observations from one or more entities about a particular location, such as the noted roadway segment, or other transportation-related areas such as pedestrian walkways, bike paths, and so on. The entities may include a variety of electronic devices including vehicles traveling over the roadway, static road-side units (RSUs) mounted along the roadway/path, mobile electronic devices carried by pedestrians/bicyclists, and so on. An entity forms an individual observation from a single temporal instance of encountering the location. Thus, the observation can include data from multiple different sensors that may span an instance in time when the entity is traveling over the roadway segment or other location. As such, the aggregated observations may be from multiple different entities that encounter the roadway segment at different times and under different conditions. Thus, the observations function as evidence of different events and characteristics associated with the location/roadway segment and/or a broader zone about the location/roadway segment.

The tagging system can analyze the observations to generate knowledge about the location/roadway segment. The knowledge describes a fact or belief about the presence of certain attributes, such as particular characteristics or occurrences of events that may be latent or otherwise more complex patterns described by the observations. The underlying aspects of the knowledge may involve complex roadway geometries, dynamic traffic conditions, weather-dependent conditions, occurrences of temporary events, and so on. In any case, the tagging system may process the observations to derive the knowledge, thereby acquiring further awareness about the location/roadway segment.

To further leverage the knowledge, the tagging system, in at least one approach, analyzes a collection of knowledge about the location to further determine commonalities that may influence movement through the location. Thus, the system can further process the acquired knowledge to determine which characteristics and events sufficiently influence movement through a zone, including the observed location, such as a roadway segment. As a result, the system identifies common zone attributes for the zone and generates tags within a map indicating the particular zone attributes. The common zone attributes may further identify abstract aspects of the location, such as latent characteristics that influence likelihoods of hazards/risks, confusion of drivers/automated systems, and so on. It should be noted that the zone attributes include aspects, in various embodiments, extending beyond traffic on a roadway segment and may further encompass aspects relating to pedestrians and other entities, such as a density of pedestrians, safety for walking through a zone, and so on.

The tagging system generally produces the tag itself as an indicator of the zone attribute, and, thus, may include a location—boundary of the zone, and other information such as suggested actions to improve movement (e.g., navigation) through the zone, safety while in the zone, and so on. As such, the system can distribute a map that includes the tag along with other tags to various entities (e.g., vehicles, pedestrians, etc.) to increase awareness about various zone attributes of a region. Moreover, in additional aspects, the tagging system can provide tags in response to queries about zones according to location, particular characteristics (e.g., dangerous areas, areas of high pedestrian traffic, etc.), and so on. In this way, the disclosed approach improves awareness about zone attributes for different zones in a transportation network, thereby facilitating movement through locations by various entities.

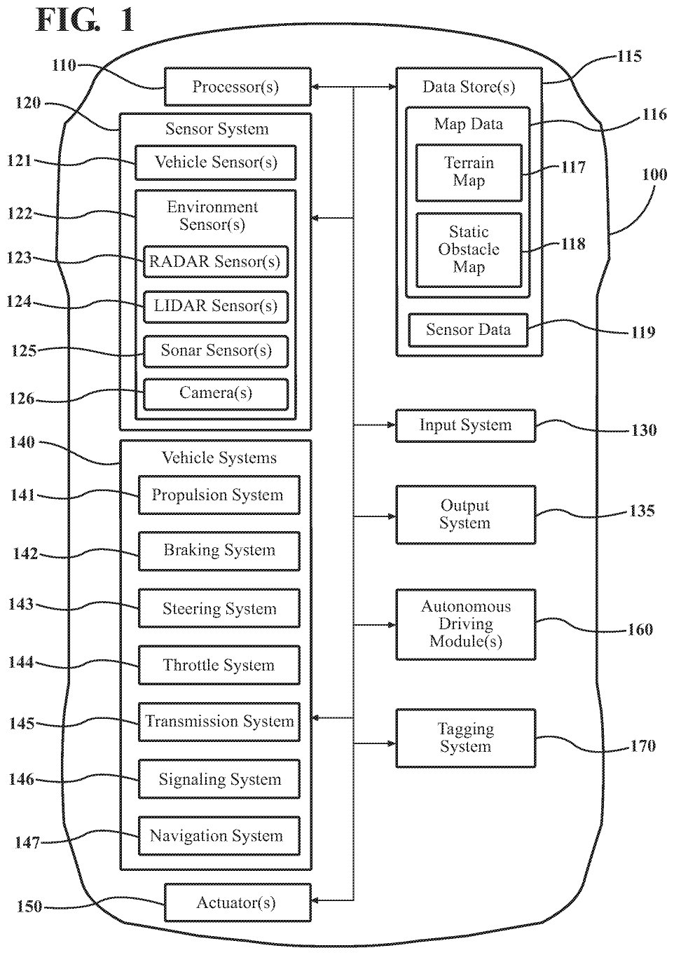

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any device that, for example, transports passengers and includes the noted sensory devices from which the disclosed determinations may be generated. Moreover, in yet further approaches, the noted systems and methods disclosed herein may be implemented as part of other entities such as electronic devices that are not associated with a particular form of transport but are instead embedded as part of the electronic devices that can be, for example, carried by an individual and that may function independently or in concert with additional systems (e.g., sensors) of other devices.

In any case, the vehicle 100 also includes various elements. It will be understood that in various embodiments, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within the vehicle 100, while further components of the system are implemented within a cloud-computing environment, as discussed further subsequently. Moreover, separate instances of the system may function in cooperation.

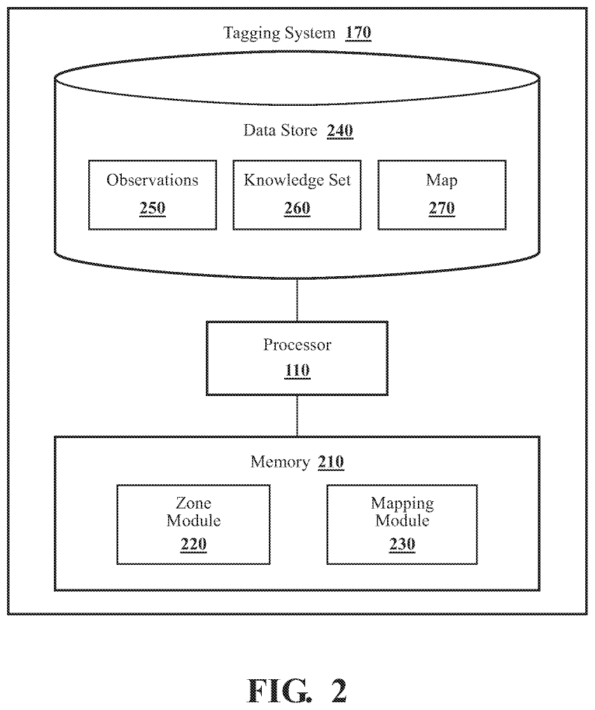

Some of the possible elements of the vehicle 100 are shown in FIG. 1 and will be described along with subsequent figures. However, a description of many of the elements in FIG. 1 will be provided after the discussion of FIGS. 2-8 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 100 includes a tagging system 170 that is implemented to perform methods and other functions as disclosed herein relating to improving awareness of an entity about zones of a transportation network.

As will be discussed in greater detail subsequently, the tagging system 170, in various embodiments, may be implemented partially within the vehicle 100, or other entity, and may further exchange communications with additional aspects of the system 170 that are remote from the vehicle 100 in support of the disclosed functions. Thus, while FIG. 2 generally illustrates the system 170 as being self-contained, in various embodiments, the tagging system 170 may be implemented within multiple separate devices some of which may be remote from the vehicle 100.

With reference to FIG. 2, one embodiment of the tagging system 170 of FIG. 1 is further illustrated. The tagging system 170 is shown as including a processor 110 from the vehicle 100 of FIG. 1. Accordingly, the processor 110 may be a part of the tagging system 170, the tagging system 170 may include a separate processor from the processor 110 of the vehicle 100 or the tagging system 170 may access the processor 110 through a data bus or another communication path. In further aspects, the processor 110 is a cloud-based resource that communicates with the system 170 through a communication network. In one embodiment, the tagging system 170 includes a memory 210 that stores a zone module 220 and a mapping module 230. The memory 210 is a random-access memory (RAM), read-only memory (ROM), a hard-disk drive, a flash memory, or other suitable memory for storing the modules 220 and 230. The modules 220 and 230 are, for example, computer-readable instructions within the physical memory 210 that, when executed by the processor 110, cause the processor 110 to perform the various functions disclosed herein.

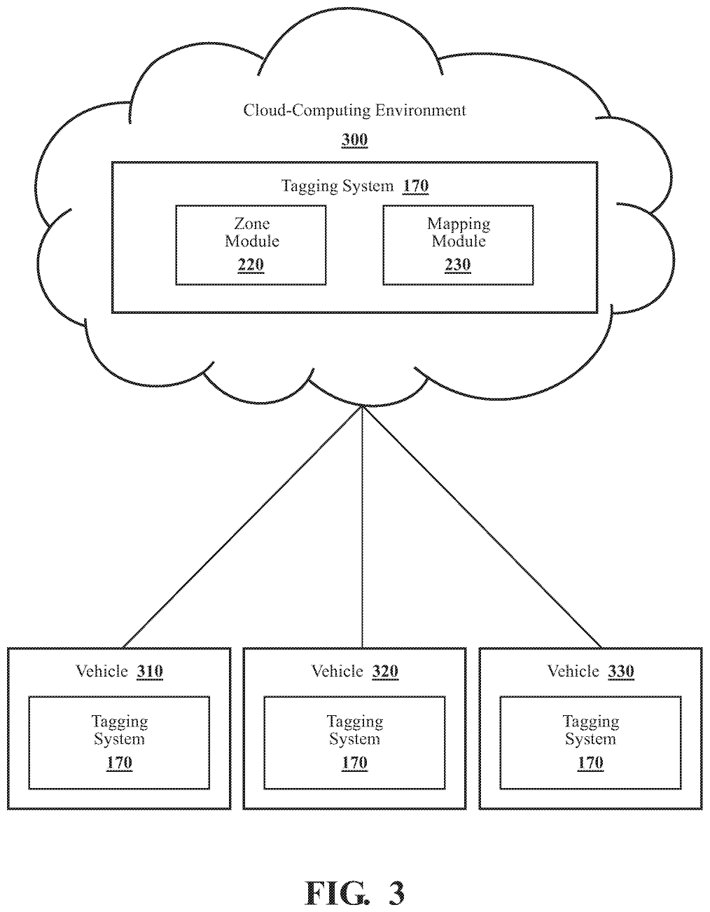

The tagging system 170 may be further implemented as a cloud-based system that functions within a cloud-computing environment 300 as illustrated in relation to FIG. 3. That is, for example, the tagging system 170 may acquire observations 250 (i.e., sensor data) from various entities, such as vehicles implementing separate instances of the system 170, and execute as a cloud-based resource that is comprised of devices (e.g., distributed servers) remote from the vehicle 100 to aggregate the observations 250 and derive the tags for the map 270 from the knowledge set 260. Accordingly, the tagging system 170 may communicate with various entities (e.g., vehicles 310, 320, and 330) that are geographically distributed. In one approach, the cloud-based tagging system 170 collects the observations 250 from components or separate instances of the system 170 that are integrated with the vehicles 310-330. As previously noted, the entities that implement the tagging system 170 may vary beyond transportation-related devices and encompass road-side units (e.g., statically mounted cameras, LiDARs, and/or other sensor-based systems), mobile devices (e.g., smartphones), and so on. Thus, the set of remote entities that function in coordination with the cloud-based environment 300 may be varied. Moreover, the entities described herein generally operate within a transportation network that broadly includes locations beyond traditional roadways encompassing, for example, pedestrian pathways, bike paths/lanes, roads, highways, and so on.

Of course, the entities, such as the vehicles 310-330, may communicate with the cloud-computing environment 300 using various forms of communications to provide the observations 250, to acquire the map 270, and/or to query the map 270. As such, the cloud-based aspects of the system 170 may process the observations 250 for the vehicles 310-330 to generate the tags within the map 270. Of course, in further aspects, the entity-based components of the system 170 may perform part of the processing while the cloud-computing environment 300 may handle a remaining portion of processing or function to validate and aggregate results of the entity-based systems 170 (310-330). It should be appreciated that the apportionment of the processing between the remote entities and the cloud may vary according to different implementations. Additionally, it should be appreciated that while three separate entities are illustrated along with FIG. 3, the cloud-computing environment 300 generally communicates with a varying number of entities that may be distributed over a wide geographic area.

Continuing with FIG. 2, in one embodiment, the zone module 220 includes instructions that function to control the processor 110 to acquire sensor data in order to generate an observation. Broadly, an observation as acquired by an entity is, in one aspect, information about a particular location (e.g., roadway segment, pedestrian pathway, etc.) derived from the sensor data of at least one sensor. In further aspects, the observation may also include event data harvested by the system 170 from electronic sources (e.g., Internet, municipalities, etc.) about current events including schedules (e.g., days and times) for the events, locations, and so on. The current events include, for example, conferences, sporting events, performances, fairs, festivals, and so on. Thus, the observation, which may also be broadly referred to as information about a location, such as a roadway segment, event venue, and/or surrounding area, is generally a group of one or more data that are processed into a meaningful form. Accordingly, the observation, or collection of the observations 250, may take a particular form derived from the sensor/collected data, and may be generated by an entity that is statically positioned at the roadway segment (e.g., a road-side unit), that is traveling along or proximate to the location (e.g., a vehicle, pedestrian, etc.), or that is configured to query electronic sources for the noted data.

The zone module 220 may acquire various electronic inputs that originate from the vehicle 100 or other entity, which may be stored in a data store 240 of the tagging system 170. Accordingly, in one embodiment, the tagging system 170 includes the data store 240. The data store 240 is, in one embodiment, an electronic data structure (e.g., a database) stored in the memory 210 or another data store and that is configured with routines that can be executed by the processor 110 for analyzing stored data, providing stored data, organizing stored data, and so on. Thus, in one embodiment, the data store 240 stores data used by the modules 220 and 230 in executing various functions. In one embodiment, the data store 240 includes the observations 250 along with, for example, the knowledge set 260, the map 270, and/or other information that is used by the modules 220 and 230.

Accordingly, the zone module 220, in one embodiment, controls respective sensors of the vehicle 100 to provide the data inputs in the form of sensor data and/or current events data. The zone module 220 may further process the sensor data into separate observations of the surrounding environment. For example, the zone module 220, in one approach, fuses data from separate sensors to provide an observation about a particular aspect of the surrounding environment. By way of example, the sensor data itself, in one or more approaches, may take the form of separate images, radar returns, LiDAR returns, and so on. The zone module 220 may derive determinations (e.g., speed, object ID, position, etc.) from the sensor data and fuse the data for separate identified objects from separate pieces of sensor data, such as a speed, time, and position for an observed vehicle. The zone module 220 may further extrapolate the sensor data into an observation by, for example, correlating the separate instances of sensor data into a meaningful observation about the object beyond an instantaneous data point. For example, the zone module 220 may track the object over many data points to provide a description about the behavior of the object through a field-of-view of the vehicle 100 such that the observation characterizes the movement of the observed vehicle (e.g., Vehicle A was moving at an average speed of 25 mph at time t across position p). As a further example, the zone module 220 may derive locations of roadway features, conditions of the features as the vehicle 100 encounters the features (e.g., icy lane during a snow storm, pothole, locations of construction cones, etc.), presence of pedestrians and associated paths/trajectories, and so on.

Additionally, while the zone module 220 is discussed as controlling the various sensors to provide the sensor data, in one or more embodiments, the module 220 can employ other techniques that are either active or passive to acquire the sensor data. For example, the zone module 220 may passively sniff the sensor data from a stream of electronic information provided by the various sensors to further components within the vehicle 100. Moreover, as noted, the zone module 220 can undertake various approaches to fuse data from multiple sensors when providing the sensor data. Thus, the sensor data, in one embodiment, represents a combination of perceptions acquired from multiple sensors.

Of course, depending on the sensors that the vehicle 100 or other entity includes or otherwise accesses, the available sensor data that the tagging system 170 can harvest may vary. As one example, according to a particular implementation, the vehicle 100 may include different versions of an IMU sensor that are separately capable of different measurements about the movement of the vehicle 100. That is, in one implementation, the IMU sensor may provide yaw rate, lateral acceleration, and longitudinal acceleration, whereas, in a separate implementation with a more robust IMU sensor, the IMU sensor may provide additional data such as pitch rates, roll rates, vertical acceleration, etc. As such, the zone module 220 may, in one or more approaches, be configured to adapt to different electronic inputs depending on the availability of such information.

Moreover, the sensor data can include entity-specific data (i.e., data about the vehicle 100, such as the IMU data, vehicle control inputs, ABS activation, traction control activation, stability control activation, etc.) and/or environment-specific data, such as images from a camera, radar data, LiDAR data, etc. As further noted, the zone module 220 may collect data from electronic sources about current events for different locations. In one approach, the zone module 220 includes one or more routines that actively identify current event data from electronic sources, such as community websites, event venue information sources, and/or other electronic sources that report the noted data. In any case, the zone module 220 acquires the sensor/event data and generates the observations 250 therefrom. In various approaches, the zone module 220 may then communicate the observations 250 to the cloud-computing environment 300 or locally process the observations 250 into knowledge about associated locations (e.g., roadway segments, event areas, etc.) described therein.

Thus, the zone module 220 analyzes the observations 250 about a roadway segment to correlate the observations into knowledge about the location. That is, the zone module 220 processes the observations for, in one embodiment, the same location together to produce knowledge about the location. As used herein, zone, in at least one embodiment, is intended to encompass an area of the observation including the roadway segment/location and areas extending beyond the roadway segment/location that are effected by characteristics/events of the roadway segment/location that generally characterize a zone attribute of the broader zone. Thus, a zone may be isolated to a single lane of a segment of a roadway (e.g., a turn lane at a single intersection) or may be defined according to a broader geographic area of a transportation network (i.e., a connected network of roadways, an area about an event venue, etc.) according to traffic (i.e., vehicle and pedestrian) and/or other aspects that flow from a characteristic/event. Accordingly, the zone is generally defined according to aspects of the zone attribute and is dependent on specific details thereof.

Additionally, in a further approach, the zone may be independent of a particular location and can instead migrate across geographic areas. In such a case, the noted characteristic may originate in a particular zone (e.g., congestion develops at a known point) and proceeds to influence other areas while either remaining constant or dissipating at the point of origin. Thus, the particular dynamic aspects of the zone may be independently defined according to the characteristic/event as described further subsequently.

Returning to the discussion of knowledge for a location, in one approach, analyzing the observations 250 for a given location involves applying a knowledge model to the observations to extract relationships corresponding to the knowledge and indicating at least one of a characteristic and an event associated with the location. That is, the knowledge model may be trained to identify relationships between separate instances of observations that correspond with particular aspects of a location. In general, the knowledge derived from the observations 250 characterizes an event or a characteristic of the location.

For example, the event generally describes an occurrence associated with a single entity or group of entities traveling through the region of the roadway segment such as confusion of a vehicle navigating through the zone, construction of the roadway segment, school in progress near the location, the presence of pedestrians near the location, congestion of the location (e.g., roadway segment, pedestrian walkway/path, bike lane, etc.), and so on. On the other hand, the characteristic refers to intrinsic aspects of the location and surrounding environment, such as a roadway geometry associated with the location, traffic signals/signs proximate to the location, dangerous conditions of the location (e.g., potholes, etc.), effects on the location due to weather or time of day, and so on. Furthermore, depending on the particular nature of the event or characteristic, either may be associated with increased traffic, an increased danger/risk of traveling through the zone, confusion in navigation, and so on.

In any case, the zone module 220 uses the knowledge model to generate the knowledge, which is aggregated into the knowledge set 260, from the observations 250. In one embodiment, the knowledge model is a learning model that infers relationships between separate ones of the observations 250 to identify the events and characteristics associated with the roadway segment. It should be appreciated that the zone module 220, in combination with the knowledge model, can form a computational model such as a machine learning model/algorithm, deep learning model, a neural network model, or another similar data analysis structure. In one embodiment, the knowledge model is a statistical model that correlates similar aspects of the observations 250 to infer the knowledge. Moreover, in alternative arrangements, the knowledge model is a probabilistic approach, such as a hidden Markov model.

In any case, the zone module 220, when implemented as a machine learning model or another model, electronically accepts the observations 250 as an electronic input. Accordingly, the zone module 220 in concert with the knowledge model produce various determinations/assessments as an electronic output that characterize the noted aspects as, for example, separate electronic values. Additionally, as a further aspect, the tagging system 170 may train the knowledge model to learn various parameters (e.g., hyper-parameters, coefficients, etc.) through a supervised learning process (i.e., with labeled data), an unsupervised process, a semi-supervised process, or as may be otherwise suitable. Accordingly, in one or more aspects, observations and/or sensor data may be logged, correlated with known events/characteristics, and used to train the knowledge model. As an additional note, the training may occur locally within the vehicle 100/entity or as a separate process in the cloud-computing environment 300.

As a result of the analysis of the observations 250 about the location, the tagging system 170 is able to develop a further understanding of the location via the knowledge that embodies the identified relationships/patterns in the form of facts or at least beliefs about the location. As noted, the knowledge identifies characteristics and events associated with the location that may be difficult to detect, latent, or at least not immediately obvious and for which prior awareness can facilitate movement through or around the location to better support navigation or unplanned movement over the transportation network.

Thus, as a further aspect, the zone module 220 accumulates the knowledge about the location and other locations (e.g., distant or other connected roads/paths) in the form of the knowledge set 260. The knowledge set represents multiple separate determinations of instances of knowledge. Thus, by way of example, the knowledge set 260 may be comparable with knowledge of a driver about a particular intersection or another roadway segment from a plurality of instances of encountering the roadway segment for different temporal and spatial conditions (e.g., different approaches to a same intersection). Thus, the tagging system 170 accumulates the knowledge set 260 from which the zone module 220 can extrapolate deeper inferences such as characteristics and events that are, for example, common to the roadway segment and/or are of greater likelihood under certain conditions.

Accordingly, the zone module 220, in one or more embodiments, defines a tag for a zone associated with the location according to a pattern within the knowledge set 260. The zone attribute corresponding with the pattern indicates a characteristic or event of the location in a realized form that defines a scope of an impact on traveling through the zone. That is, the zone attribute specifies an increased risk/hazard to the vehicle 100/entity, an effect on traffic congestion in the zone, complications with navigation, and other associated aspects arising from the common characteristic/event identified by the pattern.

In general, the zone module 220 identifies the pattern by analyzing the knowledge set to determine whether aspects (i.e., characteristic/event) associated with separate knowledge of the knowledge set 260 occur with a sufficient frequency to influence movement (e.g., navigation, unplanned movement, etc.) through the zone. Consequently, the tagging system 170 may define a threshold as a point of comparison to determine whether the frequency of the characteristic/event or aspects associated therewith are adequate (e.g., every week or with common frequency per the occurrence of dynamic conditions) or at least not spurious occurrences. In one embodiment, the zone module 220 includes a separate model for analyzing the knowledge set 260. Thus, the zone module 220, in one approach, applies a model to the knowledge set and the observations from which the knowledge set is derived to infer the pattern from correlations between characteristics and events for the location that are described by the knowledge set 260.

The zone module 220, in one approach, defines a tag according to the identified zone attribute from the analysis of the knowledge set 260. In one embodiment, the zone module 220 generates the tag as an indicator about aspects of the zone, which an entity that is potentially navigating through zone should be aware. Thus, the tag generally functions as a mechanism of conveying prior knowledge to the entity even though the entity may not have previously encountered the zone. As such, the zone module 220 generates the tag to include various identifying information about the zone, such as an identifier that characterizes the zone attribute (e.g., zone type—dangerous, pedestrians, confusion zone, congestion, construction, etc.), a location of the zone (e.g., latitudes and longitudes of a boundary of the zone), a contextual indicator specifying whether the zone attribute is one of dynamic and static, dynamic conditions (e.g., weather, time of day, day of week, etc.) that identify when the zone attribute associated with the tag is present/likely occurring, and suggested actions for mitigating an effect of the zone attribute on traveling through the zone. Of course, in further or alternative arrangements, the tag may include fewer or more elements as may be defined according to a particular embodiment.

Regarding the listed aspects of the tag, the identifier may specify that the zone is static or dynamic. That is, the identifier indicates whether the zone attribute depends on temporal conditions, environmental conditions, or some other aspect that is not static, such as time of day, weather, and so on. By contrast, a zone having a static type may be associated with various time-invariant features such as no GPS signal due to placement of infrastructure that static, poor traffic signs that cause navigational errors/confusion, road geometries, and so on. Accordingly, a dynamic tag may further indicate dynamic conditions that specify a particular function as to when the condition is likely to be present in the zone. By way of example, the function may indicate weather conditions, a threshold level of traffic, a time of day (e.g., associated with school and the presence of pedestrians, an event—sporting event, concert, etc.), and/or other characterizing information from which an entity can determine when the tag is active. Therefore, an entity, such as a vehicle, may acquire sensor data in real-time and compare the sensor data against the information specified by the tag to determine whether the conditions associated with the tag are likely active.

The zone tag identifier may further indicate a particular aspect about the zone attribute such as whether the zone is an area of increased hazard (e.g., increased risk of traffic accident at a particular intersection, merge, or another aspect of a roadway), pedestrian zone (i.e., numerous pedestrians present), a school zone, congestion zone, confusion zone, and so on. In yet a further aspect, the tag can specify suggested actions for mitigating the zone attribute. By way of example, when a vehicle is operating in an autonomous mode, the vehicle may handover operation to a driver when the tag indicates a confusion zone where autonomous vehicles are likely to encounter navigation difficulties. As a further example, a vehicle may adapt a route to avoid an area with high congestion during school release. In still a further example, the suggested action may indicate that a slower speed is best to avoid hazards from a hidden drive or the presence of children. In a further example, the suggested action may specify explicit directions to avoid confusing road signs or a roadway geometry. In general, the suggested actions may include numerous different actions that facilitate movement through the zone. The actions may be derived from the observations 250 of entities that avoid the difficulties identified by a particular tag, may be manually labeled, or may be derived by the model that generates the tags. The suggested actions function to further facilitate movement through the zone.

In any case, the zone module 220 defines the location (e.g., boundaries) of the zone in order to inform entities about where the zone attributes occur. In one approach, the zone module 220 determines boundaries of the zone according to an extent of the impact associated with the zone attribute relative to the location. For example, some zone attributes, such as areas of common navigational confusion, may be isolated to a discrete roadway feature. The roadway feature may be a particular lane, an intersection, etc. Thus, in such a case, the zone module 220 defines the boundary of the zone as the lane or intersection. However, in further aspects, the zone attribute may have a broader impact that influences traffic along additional portions of the transportation network. For example, a construction zone or school zone may impact traffic far beyond the action-specific location of the construction or of the school since traffic proceeding through the area may backup for considerable distances beyond construction or location of the school. Thus, in such a case, the zone module 220 defines the zone according to the impact of the characteristic/event, which results in a much broader zone than in the case of confusion about navigation indicators. Accordingly, the noted examples generally specify endpoints within a range of zone sizes. It should be appreciated that further forms of zones may specify boundaries that are within the noted range and likely have an extent associated with a narrow geographic region, such as an intersection and roadways leading into the intersection for a specified distance (e.g., 500 m), areas directly around an event venue, and so on.

Continuing with FIG. 2, in one embodiment, the mapping module 230 includes instructions that, when executed by the one or more processors 110, cause the one or more processors 110 to distribute the map 270 of tags. First, consider that the mapping module 230 accepts the tag from the zone module 220 and integrates the tag into the map 270. The map 270 is, in one embodiment, a road map that includes a transportation network comprised of at least roadways, sidewalks, pedestrian paths, bike lanes, and other relevant features. The map 270 may be generated in different levels of detail according to the particular implementation. For example, in one embodiment, the map 270 may specify a level of abstraction that details roadways without specificity about lanes, sidewalks, bike paths and other smaller features.

In a further implementation, the map 270 may include a higher level of detail that includes lane mappings, traffic signals, and further aspects of roadways and proximate areas. In any case, the mapping module 230 tags or annotates the map 270 with the tags produced by the zone module 220. Thus, the mapping module 230 integrates information about the separate tags into the map 270 such that the tags specify zones and relate the zone attributes to particular locations while defining specific boundaries of the tags. Accordingly, the map 270 can serve as a navigational map for route planning and as a point of comparison against a location of a particular entity in order to convey knowledge about the zones prior to an entity actually encountering the zones. Additionally, the map 270 may be segmented according to different geographic regions (e.g., cities/counties) in order to optimize the use of bandwidth in communicating the map 270.

The mapping module 230 further functions, in one or more arrangements, to electronically communicate the map 270 or at least the tags to various entities. For example, the mapping module 230 may function to communicate the map 270, including the noted tags to various edge devices, directly to mobile entities (e.g., vehicles, smartphones, etc.), to the cloud-computing environment 300, and so on. Generally, the mapping module 230 can communicate the map 270 or relevant portions thereof to different entities depending on a point of origin of the map 270. For example, in an instance when an entity such as the vehicle 100 independently generates tags in the map 270, the mapping module 230 may communicate the map 270 to the cloud 300 for distribution to edge devices and other entities. In an instance where the tagging system 170 in the cloud 300 generates the map 270, the mapping module 230 may communicate the map 270 to various edge devices or distribute servers and then subsequently communicate the map 270 or a segment for a local region to an entity.

For example, in one embodiment, the mapping module 230 communicates the map 270 or a portion thereof to an entity in response to a request from the entity. That is, as a vehicle or other device plans a route, moves into a region, and/or desires further awareness about a location, the entity may request the local knowledge embodied in the tags of the map 270 from an edge device (e.g., a road-side unit) or the cloud 300 in order to gain awareness about particular aspects of the transportation network in that locality. The entity may then use the information in the map 270 to adapt movement through the identified zones to improve progress around hazards and other noted zone attributes. As a further example, an entity may request information about dangerous locations within a broader region. Thus, the mapping module 230 functions to process a query against the tags within the map 270 in order to identify zone having the particular characteristics. The mapping module 230 can then communicate the tags or the map 270 in order to provide the information to the entity. In this way, the tagging system 170 provides for improving awareness of the entity about aspects of the transportation network to facilitate movement through the zones.

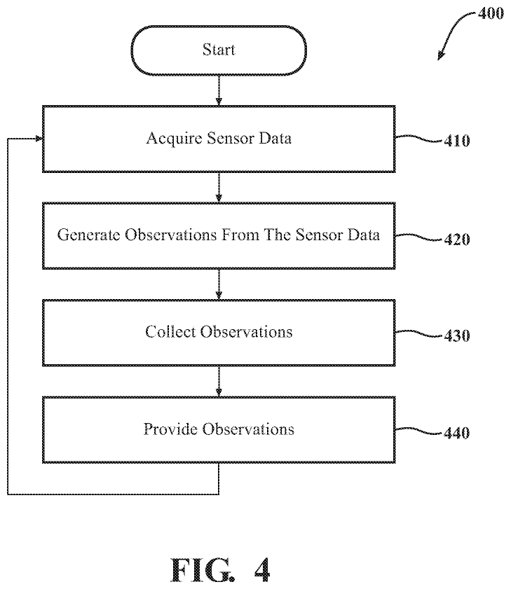

FIG. 4 illustrates a flowchart of a method 400 that is associated with collecting observations about a transportation network. Method 400 will be discussed from the perspective of the tagging system 170 of FIGS. 1-3. In particular, the method 400 focuses on the collection of observations by an entity such as a vehicle. While method 400 is discussed in combination with the tagging system 170, it should be appreciated that the method 400 is not limited to being implemented within the tagging system 170 but is instead one example of a system that may implement the method 400. Furthermore, while the method is illustrated as a generally serial process, various aspects of the method 400 can execute in parallel to perform the noted functions.

At 410, the zone module 220 acquires data about a present location. In one embodiment, the tagging system 170 controls the sensor system 120 to acquire the sensor data from various sensors within the vehicle 100, including environment sensors 122 and vehicle sensors 122. For example, in at least one approach, the tagging system 170 acquires the sensor data about a surrounding environment of the vehicle 100 and the inputs and response of the vehicle 100 to the surrounding environment. Thus, the zone module 220 acquires a record of the particular location and aspects about traveling through the location as the zone module 220 acquires the sensor data.

Moreover, the tagging system 170 controls the sensors to acquire the sensor data at successive iterations or time steps. Thus, the tagging system 170, in one embodiment, iteratively executes the functions discussed at blocks 410-440 to acquire the sensor data and provide information therefrom. Furthermore, the system 170, in one embodiment, executes one or more of the noted functions in parallel for separate observations. In one aspect, the tagging system 170 may be generating observations/information according to current sensor data while providing prior observations in parallel. Thus, in one approach, the tagging system 170 may execute multiple iterations of the method 400 in parallel. Additionally, in various aspects, the tagging system 170 harvests current events data from electronic sources. Thus, the tagging system 170 may include various routines that electronically communicate via the Internet or other communication network with event venues and associated sources to acquire data about when events occur, expected impacts of the events (e.g., number of attendees), and other relevant information.

At 420, the zone module 220 generates an observation from the acquired data. As noted previously, in one embodiment, the process of generating the observation from the sensor/event data may involve different aspects such as identifying objects, fusing separate portions of the sensor data together for individual objects, tracking the objects, distinguishing static and dynamic aspects of a scene, and collating the separate pieces of information about different aspects of the surroundings into a cohesive observation that generally characterizes the distinct aspects. For example, the observations may comprise multiple different pieces of sensor data taken over an observation period while the vehicle 100 is traveling along a roadway segment or through a roadway segment with a particular feature (e.g., intersection, ramp, merge, etc.). Thus, the zone module 220 can combine the separate pieces of data to characterize behaviors of dynamic objects and conditions of different static features (e.g., road surface conditions). In this way, the zone module 220 generates the observation.

At 430, the zone module 220 collects the observation to form a repository or database of observations 250. For example, zone module 220, in one approach, stores the observation in the data store 240 in order to aggregate observations for a location from which further determinations may be subsequently derived. In one or more arrangements, the zone module 220 may index the observations 250 according to location, depicted objects, day/time, and/or other features.

At 440, the zone module 220 provides the observations 250. In one embodiment, the zone module 220 intermittently communicates the observations 250 to a central repository, such as the cloud-computing environment or a regional repository (e.g., a knowledge server that functions in cooperation with the cloud 300). In further aspects, the zone module 220 may maintain a local copy of the observations 250 and perform an independent analysis to generate knowledge therefrom. However, in general, the tagging system 170 benefits from acquiring observations from a plurality of different entities (e.g., vehicles, pedestrians, road-side units, etc.) in order to acquire a more comprehensive set of observations about a geographic area. In this way, the tagging system 170 is more likely to acquire observations that permit the harvesting of patterns to better identify characteristics/events of different zones.

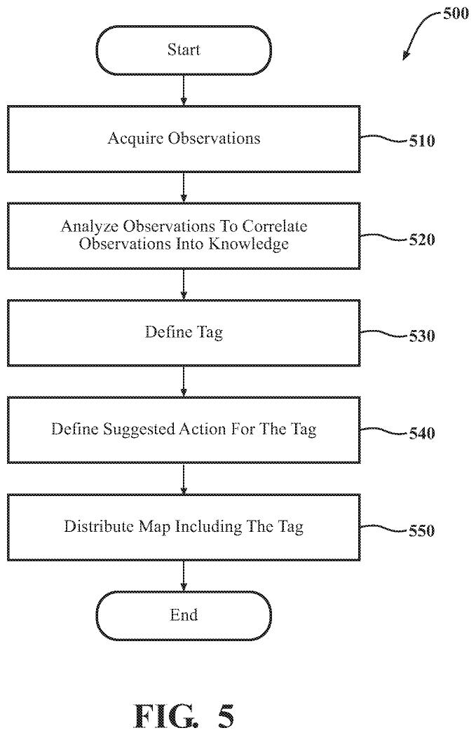

FIG. 5 illustrates a flowchart of a method 500 that is associated with improving awareness about aspects of locations associated with a transportation network. Method 500 will be discussed from the perspective of the tagging system 170 of FIGS. 1-3. In particular, the method 500 focuses on analyzing observations and knowledge in order to generate tags for different zones. While method 500 is discussed in combination with the tagging system 170, it should be appreciated that the method 500 is not limited to being implemented within the tagging system 170 but is instead one example of a system that may implement the method 500. Furthermore, while the method is illustrated as a generally serial process, various aspects of the method 500 can execute in parallel to perform the noted functions.

At 510, the zone module 220 acquires the observations 250. As previously explained, the zone module 220 may acquire the observations 250 locally from sensor data or may acquire the observations 250 from other entities that communicate the observations to the tagging system 170. Accordingly, the observations 250 may represent information acquired by multiple different entities but is generally configured in a common format that is standardized between the various entities. The zone module 220 may aggregate the observations 250 from the different sources and may further index the observations 250 according to location and other characteristics.

At 520, the zone module 220 analyzes the observations 250, or a subset thereof, about a location (e.g., roadway segment) to correlate the observations 250 into knowledge about the location. As previously detailed, the zone module 220, in one approach, analyzes the observations 250 about the location by applying a knowledge model to the observations 250. The knowledge model extracts relationships corresponding to the knowledge and indicating a particular aspect of the location, such as a characteristic and/or an event that corresponds with the relationships between the observations. In this way, the zone module 220 generates multiple separate pieces of knowledge about a roadway segment over time. The knowledge itself may include many different aspects, such as events, which may include confusion traveling through the zone, construction of the roadway segment, school in progress near the roadway segment, the presence of pedestrians near the roadway segment, congestion of the roadway segment, and so on. The knowledge may further include characteristics, such as a roadway geometry associated with the roadway segment, locations of traffic signals proximate to the roadway segment, dangerous conditions of the location, and effects on the roadway segment due to weather or time of day that influence the ability to traverse the roadway segment and that may cause congestion.

At 530, the zone module 220 defines a tag for a zone associated with the location according to a pattern within the knowledge set 260. The knowledge set 260 refers to knowledge accumulated about a location from analyzing multiple sets of observations over time. Thus, the zone module 220 analyzes the accumulated knowledge to identify patterns that are indicative of common zone attributes for a location and associated zone. The zone attributes generally align with the knowledge itself and represent frequent or common aspects derived as knowledge from the observations. This analysis may involve the use of a model (e.g., machine learning model, statistical model, etc.) applied to the knowledge set 260 and the observations 250 from which the knowledge set is derived to infer the pattern. As part of defining a tag, the zone module 220 embeds the tag with various information, as previously outlined.

At 540, the zone module 220 defines a suggested action for the tag. It should be appreciated that not all of the tags may include a suggested action; however, tags that do include the suggested action may specify a variety of different actions that generally depend on the nature of the tag itself. For example, the suggested action may specify to handover control to a driver from an autonomous system when autonomous vehicles have difficulties driving through a particular area. In further examples, the suggested actions may be to reduce speed to avoid hazards, such as bicyclists, children, etc. In yet further embodiments, the suggested actions may include explicit directions to overcome confusing traffic signals or roadway configurations. Moreover, the suggested actions may specify travel times and a threshold level of congestion for rerouting. In any case, the suggested actions are integrated with the respective tags and into the map 270.

At 550, the mapping module 230 distributes the map 270 including the tags to facilitate entities traveling through the zone. As described previously, the mapping module 230 may distribute segments of the map 270 to edge devices located within a locality or may distribute the map 270 or a portion thereof directly to a requesting entity. In any case, the mapping module 230 provides at least the tag to cause one or more entities to adapt movement through the zone, thereby improving progress of the one or more entities through the zone and the transportation network overall.

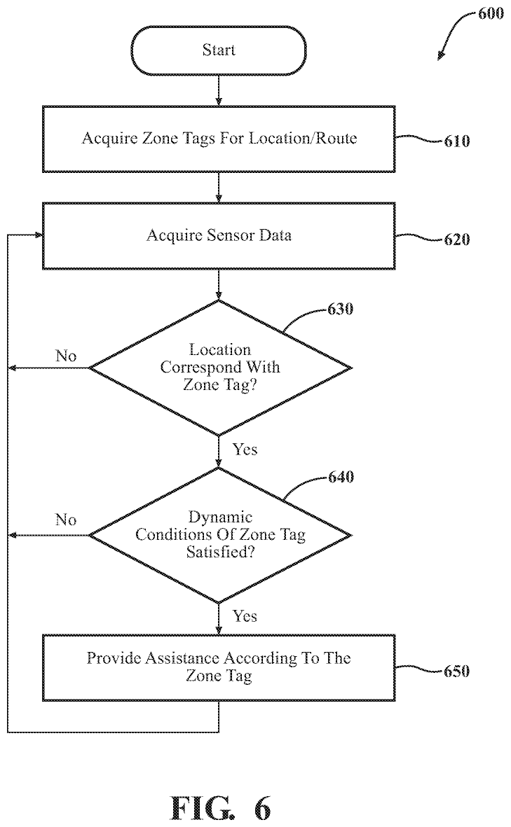

FIG. 6 illustrates a flowchart of a method 600 that is associated with improving awareness about aspects of traveling through a location of a transportation network. Method 600 will be discussed from the perspective of the tagging system 170 of FIGS. 1-3. In particular, the method 600 focuses on using a map that includes zone tags to improve awareness about attributes of different zones. While method 600 is discussed in combination with the tagging system 170, it should be appreciated that the method 600 is not limited to being implemented within the tagging system 170 but is instead one example of a system that may implement the method 600. Furthermore, while the method is illustrated as a generally serial process, various aspects of the method 600 can execute in parallel to perform the noted functions.

At 610, the tagging system 170 operating within an entity (e.g., the vehicle 100) acquires zone tags for a location and/or a route. In one embodiment, the tagging system 170 provides relevant information, such as a current location, a heading, and/or a planned route to the cloud-computing environment 300 or a local edge computing device that is storing the map 270 for a particular locality as a request. In further aspects, the request may include specific characteristics the entity is seeking to encounter (e.g., areas of high pedestrian density) or avoid (e.g., dangerous areas). In response to the request, the tagging system 170 (e.g., within vehicle 310 or another remote entity) acquires the map 270, or at least relevant tags for qualifying zones, with relevant information for a particular location.

At 620, the tagging system 170 acquires sensor data. Similar to the discussion provided in relation to block 410 of method 400, the tagging system 170 controls various sensors of the vehicle 100 or other entity to acquire sensor data about the surrounding environment. The tagging system 170 may further process the sensor data to derive observations about the surrounding environment, such as the presence of various objects, weather conditions, location, and so on. The tagging system 170 may implement a variety of processing routines or leverage processing capabilities of other systems such as an autonomous driving module 160. In any case, the tagging system 170 can assess the surroundings of the vehicle 100 according to the sensor data.

At 630, the tagging system 170 determines whether the location of the vehicle 100 corresponds with a zone tag in the map 270. In one embodiment, the tagging system 170 may determine the correspondence at block 630 in several different ways. For example, in a simplest form when, for example, there is no planned route, the tagging system 170 compares a current location against the map 270 and determines whether the current location corresponds with a zone tag. In a further approach, the tagging system 170 may attempt to infer a route of the vehicle 100 and whether the inferred route is to correspond with any zone tags in the map 270. In an approach, where the tagging system 170 is aware of an explicit planned route (e.g., from the navigation system 147), the tagging system 170 can directly compare the planned route with the map 270. In any case, the tagging system 170 iteratively compares the current location to the map 270 as the vehicle 100 progresses to determine when a zone tag matches the location.

At 640, the tagging system 170 determines whether any dynamic conditions associated with the zone tag are satisfied in order to consider the zone tag as being active. For example, in an instance where a zone tag indicates the conditions associated with the tag only occur at night, the tagging system 170 determines whether the conditions exist prior to proceeding. If the conditions do not exist, then the tagging system 170 continues to monitor the location against the map 270 and disregards the particular zone tag. The dynamic conditions may vary according to different tags but generally include aspects such as day/time, weather, congestion levels, and so on. In various aspects, the tagging system 170 may acquire contextual information about a region such as levels of congestion on a roadway prior to encountering the zone, and, thus, the tagging system 170 uses the additional information to avoid the zone, as discussed further subsequently.

At 650, the tagging system 170 provides assistance to the vehicle 100 in order to mitigate difficulties associated with conditions in the zone. For example, as previously outlined, the tagging system 170 may specify suggested actions to facilitate traveling through the zone. As such, upon determining the location of the vehicle 100 corresponds with the zone tag, and the zone tag is active, the system 170 informs the driver and/or the autonomous driving module 160 about the zone. Providing this prior knowledge about the zone attribute associated with the zone tag allows the vehicle 100 to take actions such as adapting behaviors (e.g., reducing speed, using a particular lane, etc.), rerouting around the area, and so on in order to improve travel for the vehicle 100 and other entities by potentially relieving congestion, avoiding hazards, and so on. It should be noted that in relation to other entities, such as pedestrians, the system may provide different suggested actions. That is, different zones represent different impacts to a vehicle versus a pedestrian. Thus, the tagging system 170 may suggest that a pedestrian avoid a zone due to, for example, increased hazards to pedestrians, whereas the tagging system 170 may simply suggest that a vehicle reduce speed to avoid pedestrians. In this way, the tagging system 170 improves the awareness of the vehicle 100/entity about hazards, congestion, and other difficulties associated with a transportation network.

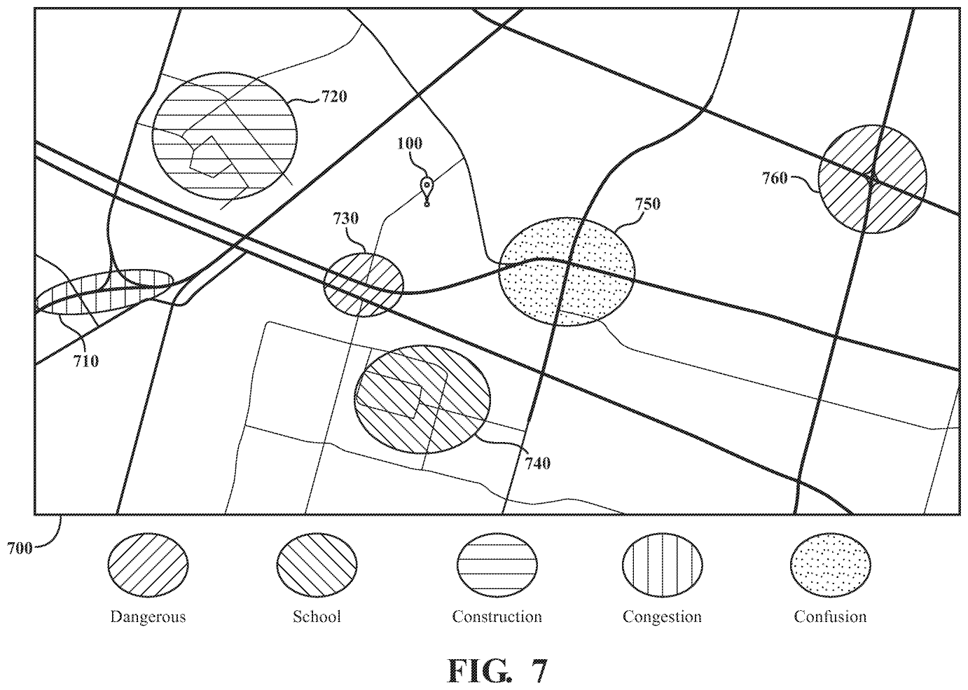

FIG. 7 illustrates one example of a map 700 that includes zone tags. As shown, the map 700 is tagged with multiple different zones having varying boundaries and other attributes. It should be noted that while each zone is generally illustrated as an ellipse, in further embodiments, the boundaries may be defined according to an extent of impact for the tag in relation to roadways and other aspects of the transportation network. Thus, the boundaries for the various zone tags may form different shapes than those illustrated in FIG. 7. In any case, the map 700 illustrates a position of the vehicle 100 and zones that are proximate to the vehicle 100. The zones include congestion zone 710, construction zone 720, dangerous intersection zone 730, school zone 740, confusion zone 750, and dangerous intersection zone 760.

Thus, as illustrated, the map 700 is an example of what the tagging system 170, as implemented in the vehicle 100, may receive upon querying a local edge device for knowledge about the geographic region around the vehicle 100. The zones specified in the map 700 may not be a comprehensive listing of zones but instead represent currently active zones or potentially active zones according to the current conditions. Thus, the vehicle 100 may use the knowledge about the zones 710-760 to improve travel through the region depicted in the map 700. Furthermore, it should be appreciated that the tagging system 170 may update the vehicle 100 with additional map segments as the vehicle 100 proceeds through the environment in order to maintain awareness about adjoining regions.

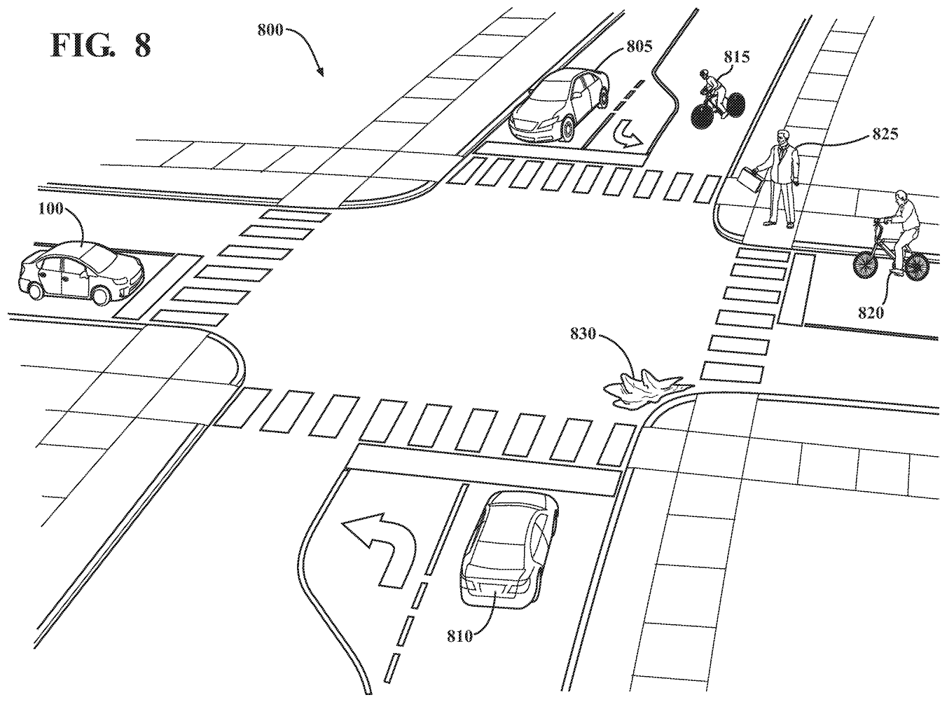

FIG. 8 illustrates another example of how the tagging system 170 may acquire observations and provide the observations to the cloud-computing system 300 to develop knowledge about an intersection 800. Accordingly, consider that the vehicle 100 includes the tagging system and is proceeding through the intersection 800. The vehicle 100 observes the vehicles 805 and 810 proceeding through the intersection and maneuvering to avoid various conditions that exist in the intersection. For example, the vehicle 810 may maneuver to avoid bicyclists 815 and 820. The vehicle 810 and 805 may also maneuver to avoid pedestrian 825 and/or pothole 830. Thus, the vehicle 100 may capture behaviors of the vehicles 805 and 810 in relation to pedestrians and other aspects of the intersection 800. These observed behaviors then become the underpinnings for knowledge derived about the intersection 800 from the observations.

For example, other vehicles traveling through the intersection may make similar observations about pedestrians and bicyclists being a common occurrence. This knowledge may further correspond with observed accidents, vehicles weaving around pedestrians and bicyclists, vehicles weaving around the pothole 830, and so on. As such, the tagging system 170 may analyze the knowledge and determine that a common zone attribute for the intersection is the presence of bicyclists and pedestrians in addition to poor road surface conditions that result in the intersection being labeled as dangerous. The tagging system 170 may further provide suggested actions to slow down, avoid the curb lane proceeding north through the intersection, watch for bicyclists/pedestrians, indicate a location of the pothole 830, and so on. In this way, the tagging system uses observations aggregated from various entities such as vehicles and provides knowledge back to the entities in the form of the zone tags to improve awareness about various zone attributes.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element, or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the tagging system 170, and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110, the tagging system 170, and/or the autonomous driving module(s) 160 may control some or all of these vehicle systems 140 and, thus, may be partially or fully autonomous.

The processor(s) 110, the tagging system 170, and/or the autonomous driving module(s) 160 can be operatively connected to communicate with the various vehicle systems 140 and/or individual components thereof. For example, returning to FIG. 1, the processor(s) 110, the tagging system 170, and/or the autonomous driving module(s) 160 can be in communication to send and/or receive information from the various vehicle systems 140 to control the movement, speed, maneuvering, heading, direction, etc. of the vehicle 100. The processor(s) 110, the tagging system 170, and/or the autonomous driving module(s) 160 may control some or all of these vehicle systems 140.

The processor(s) 110, the tagging system 170, and/or the autonomous driving module(s) 160 may be operable to control the navigation and/or maneuvering of the vehicle 100 by controlling one or more of the vehicle systems 140 and/or components thereof. For instance, when operating in an autonomous mode, the processor(s) 110, the tagging system 170, and/or the autonomous driving module(s) 160 can control the direction and/or speed of the vehicle 100. The processor(s) 110, the tagging system 170, and/or the autonomous driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine position and velocity of the vehicle 100. The autonomous driving module(s) 160 can determine the location of obstacles, obstacles, or other environmental features, including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 160 either independently or in combination with the tagging system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A tagging system for improving awareness about aspects of traveling through a transportation network, comprising:
one or more processors;
a memory communicably coupled to the one or more processors and storing:
a zone module including instructions that when executed by the one or more processors cause the one or more processors to:
analyze observations about a location to correlate the observations into knowledge about the location, and
define a tag for a zone associated with the location according to a pattern within a knowledge set that includes the knowledge for the zone, the pattern corresponding with a zone attribute of the zone; and
a mapping module including instructions that when executed by the one or more processors cause the one or more processors to distribute a mapping of tags including at least the tag to one or more entities that are to travel through the zone.

2. The tagging system of claim 1, wherein the zone module includes instructions to define the tag including instructions to identify the pattern by analyzing the knowledge set to determine whether the zone attribute associated with the knowledge set occurs with a sufficient frequency to influence travel of the one or more entities through the zone, and
wherein the zone module includes instructions to analyze the knowledge set including instructions to apply a model to the knowledge set and the observations from which the knowledge set is derived to infer the pattern from correlations between characteristics and events for the location that are described by the knowledge set.

3. The tagging system of claim 1, wherein the zone module includes instructions to define the tag including instructions to generate the tag with one or more of: an identifier that characterizes the zone attribute, a location of the zone, a contextual indicator specifying whether the zone attribute is one of dynamic and static, dynamic conditions that identify when the zone attribute associated with the tag is present, and suggested actions for mitigating an effect of the zone attribute on navigating through the zone.

4. The tagging system of claim 1, wherein the zone module includes instructions to define the tag including instructions to determine boundaries of the zone according to an extent of impact associated with the zone attribute relative to the location,
wherein the zone includes at least the location and additional portions of the transportation network that are effected by the zone attribute, and
wherein the location corresponds with one or more zones including the zone.

5. The tagging system of claim 1, wherein the knowledge characterizes at least one of an event and a characteristic associated with the location,
wherein the event includes one of confusion navigating through the zone, construction of the location, school in progress near the location, a presence of pedestrians near the location, and congestion of the location, and
wherein the characteristic includes one of a roadway geometry associated with the location, at least one traffic signal proximate to the location, dangerous conditions of the location, and effects on the location due to weather or time of day.

6. The tagging system of claim 1, wherein the zone module includes instructions to analyze the observations about the location including instructions to apply a knowledge model to the observations to extract relationships corresponding to the knowledge and indicating at least one of a characteristic and an event associated with the location,
wherein the observations are information about the location derived from sensor data of at least one sensor, and wherein the observations are provided by at least one of a vehicle, a roadside unit, and a pedestrian.

7. The tagging system of claim 1, wherein the mapping module includes instructions to distribute the mapping including instructions to electronically communicate the tag in response to a query from the one or more entities about a characteristic that matches the tag.

8. The tagging system of claim 1, wherein the mapping module includes instructions to distribute the mapping with the tag including instructions to electronically communicate the mapping in response to the one or more entities approaching the zone, and
wherein the tag causes the one or more entities to adapt travel through the zone to improve progress of the one or more entities, the travel including one or more of navigation and behavior while moving relative to the zone.

9. A non-transitory computer-readable medium storing instructions for improving awareness about aspects of traveling through a transportation network and that when executed by one or more processors cause the one or more processors to:
analyze observations about a location to correlate the observations into knowledge about the location;
define a tag for a zone associated with the location according to a pattern within a knowledge set that includes the knowledge for the zone, the pattern corresponding with a zone attribute of the zone; and
distribute a mapping of tags including at least the tag to one or more entities that are to travel through the zone.

10. The non-transitory computer-readable medium of claim 9, wherein the instructions to define the tag include instructions to identify the pattern by analyzing the knowledge set to determine whether the zone attribute associated with the knowledge set occurs with a sufficient frequency to influence travel of the one or more entities through the zone, and
wherein the instructions to analyze the knowledge set include instructions to apply a model to the knowledge set and the observations from which the knowledge set is derived to infer the pattern from correlations between characteristics and events for the location that are described by the knowledge set.

11. The non-transitory computer-readable medium of claim 9, wherein the instructions to define the tag include instructions to generate the tag with one or more of: an identifier that characterizes the zone attribute, a location of the zone, a contextual indicator specifying whether the zone attribute is one of dynamic and static, dynamic conditions that identify when the zone attribute associated with the tag is present, and suggested actions for mitigating an effect of the zone attribute on traveling through the zone.

12. The non-transitory computer-readable medium of claim 9, wherein the instructions to define the tag include instructions to determine boundaries of the zone according to an extent of impact associated with the zone attribute relative to the location,
wherein the zone includes at least the location and additional portions of the transportation network that are effected by the zone attribute, and
wherein the location corresponds with one or more zones including the zone.

13. The non-transitory computer-readable medium of claim 9, wherein the knowledge characterizes at least one of an event and a characteristic of the location,
wherein the event includes one of confusion navigating through the zone, construction of the location, school in progress near the location, a presence of pedestrians near the location, and congestion of the location, and
wherein the characteristic includes one of a roadway geometry associated with the location, at least one traffic signal proximate to the location, dangerous conditions of the location, and effects on the location due to weather or time of day.

14. A method of improving awareness about aspects of traffic associated with a transportation network, comprising:
analyzing observations about a location to correlate the observations into knowledge about the location;
defining a tag for a zone associated with the location according to a pattern within a knowledge set that includes the knowledge for the zone, the pattern corresponding with a zone attribute of the zone; and
distributing a mapping of tags including at least the tag to one or more entities that are to travel through the zone.

15. The method of claim 14, wherein defining the tag includes identifying the pattern by analyzing the knowledge set to determine whether the zone attribute associated with the knowledge set occurs with a sufficient frequency to influence travel of the one or more entities through the zone, and
wherein analyzing the knowledge set includes applying a model to the knowledge set and the observations from which the knowledge set is derived to infer the pattern from correlations between characteristics and events for the location that are described by the knowledge set.

16. The method of claim 14, wherein defining the tag includes generating the tag with one or more of: an identifier that characterizes the zone attribute, a location of the zone, a contextual indicator specifying whether the zone attribute is one of dynamic and static, dynamic conditions that identify when the zone attribute associated with the tag is present, and suggested actions for mitigating an effect of the zone attribute on traveling through the zone.

17. The method of claim 14, wherein defining the tag includes determining boundaries of the zone according to an extent of impact associated with the zone attribute relative to the location, wherein the zone includes at least the location and additional portions of the transportation network that are effected by the zone attribute, and wherein the location corresponds with one or more zones including the zone.

18. The method of claim 14, wherein the knowledge characterizes at least one of an event and a characteristic of the location,
wherein the event includes one of confusion navigating through the zone, construction of the location, school in progress near the location, a presence of pedestrians near the location, and congestion of the location, and
wherein the characteristic includes one of a roadway geometry associated with the location, at least one traffic signal proximate to the location, dangerous conditions of the location, and effects on the location due to weather or time of day.

19. The method of claim 14, wherein analyzing the observations about the location includes applying a knowledge model to the observations to extract relationships corresponding to the knowledge and indicating at least one of a characteristic and an event associated with the location,
wherein the observations are information about the location derived from sensor data of at least one sensor, and wherein the observations are provided by at least one of a vehicle, a roadside unit, and a pedestrian.

20. The method of claim 14, wherein distributing the mapping with the tag includes electronically communicating the mapping in response to the one or more entities approaching the zone, and wherein the tag causes the one or more entities to adapt travel through the zone to improve progress of the one or more entities through the zone, the travel including one or more of navigation and behavior while moving relative to the zone.
